(19) United States
(12) Patent Application Publication
(10) Pub. No.: US 2006/0025951 A1
(43) Pub. Date: Feb. 2, 2006

(54) Method for calibrating a position sensor in an electric machine

(76) Inventor: Philippe Noel, Beloeil (CA)

Correspondence Address: FAY KAPLUN & MARCIN, LLP, Suite 702, 150 Broadway, New York, NY, 10038, US

(21) Appl. No.: 10/901,363

(22) Filed: Jul. 28, 2004

(51) Int. Cl. G01C 19/00

(52) U.S. Cl. 702/104

(57) ABSTRACT

A method for calibrating a relative position sensor in an electric machine having a rotor, a stator and a relative position sensor associated with both the rotor and the stator is described. The method associates the relative angular position of the rotor with respect to the stator in an electric machine with the relative angular position measured. To that effect, the rotor is positioned at a plurality of ideal positions and the position is read from the position sensor at each of these positions.

### FIELD OF THE INVENTION

The present invention relates to electric machines. More specifically, the present invention relates to a method for calibrating a position sensor in an electric machine provided with permanent magnets.

### BACKGROUND OF THE INVENTION

Electric machines are often found in the form of polyphasic synchronous electric machines having a stator and a rotor. The operation of such machines is greatly improved if the current of each phase injected into the stator is precisely controlled. To that effect, the position of the rotor with respect to the stator must be known.

Two types of positions sensors may be used in electric machines: relative position sensors and absolute position sensors. On the one hand, relative position sensors are rarely used since they are incremental sensors that do not provide data other than relative movements and will not be further discussed herein. On the other hand, absolute position sensors may be incremental sensors that provide an index position or reference encoders that directly supply angle data.

In any case, when an absolute position sensor is mounted to an electric machine, a calibration procedure must be used since there is a difference between a returned angle of the sensor and an actual angle of the rotor with respect to the stator of the machine.

Against this background, there exists a need in the industry to provide a novel method for calibrating a position sensor in an electric machine.

### OBJECTS OF THE INVENTION

An object of the present invention is therefore to provide an improved method for calibrating a position sensor in an electric machine.

### SUMMARY OF THE INVENTION

In a broad aspect, the invention provides a method for calibrating a position sensor in an electric machine including a stator and a rotor, the position sensor providing an angular position of the rotor with respect to the stator; for each of a plurality of predetermined ideal positions, said method comprising the steps of:

injecting an electric signal into the stator such as to position the rotor in proximity to the predetermined ideal position;

reading a measured position from the position sensor, the measured position being associated to the predetermined ideal position;

computing an offset associated with the predetermined ideal position from the measured position and the initial position; and

storing the offset, thereby mapping the measured position to the predetermined ideal position.

According to another broad aspect of the present invention, there is provided an electric machine comprising:

a stator;

a rotor;

a position sensor so connected to said rotor and to said stator as to measure an angular position of said rotor with respect to said stator;

a controller for controlling an operation of said electric machine, said controller using positions read from said position sensor to control the operation of said electric machine, said controller being operative to perform a calibration of said position sensor by:

for each predetermined ideal position from a plurality of predetermined ideal positions:
injecting an electric signal into the stator such as to position the rotor in proximity to the predetermined ideal position;
reading a measured position from the position sensor, the measured position being associated to the predetermined ideal position;
computing an offset associated with the predetermined ideal position from the measured position and the initial position; and
storing the offset, thereby mapping the measured position to the predetermined ideal position.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings:

FIG. 1 illustrates an electric machine, in the form of an electric motor, provided with an angular position sensor and connected to a controller;

FIG. 2 is a schematic cross section of the electric machine of FIG. 1 with the rotor positioned at a first angular position with respect to the stator;

FIG. 3 illustrates a schematic cross section of the electric machine of FIG. 1 with the rotor positioned at a second angular position with respect to the stator;

FIG. 4 illustrates a schematic cross section of the electric machine of FIG. 1 with the rotor positioned at a third angular position with respect to the stator;

FIG. 5 illustrates a schematic cross section of the electric machine of FIG. 1 with the rotor positioned at a fourth angular position with respect to the stator;

FIG. 6 illustrates a schematic cross section of the electric machine of FIG. 1 with the rotor positioned at a fifth angular position with respect to the stator;

FIG. 7 illustrates a schematic cross section of the electric machine of FIG. 1 with the rotor positioned at a sixth angular position with respect to the stator;

FIG. 8 illustrates a schematic cross section of the electric machine of FIG. 1 with the rotor positioned at a seventh angular position with respect to the stator; and

FIG. 9 is flow chart illustrating a method for calibrating a position sensor according to another aspect of the present invention.

### DETAILED DESCRIPTION

The present invention includes a method for calibrating a position sensor in an electric machine. The method associates the actual angle position of a rotor with respect to a stator in an electric machine with an angle position returned by a position sensor. To that effect, the rotor is positioned at a plurality of ideal positions and a corresponding returned angle position is read from the position sensor at each of these actual angle positions.

The method is described in further details hereinbelow. However, an example of an electric machine, in the form of an electric motor, with respect to which the method is described is first presented.

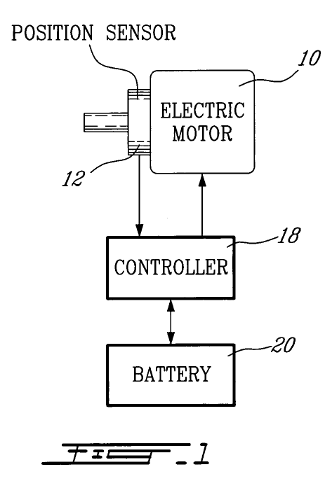

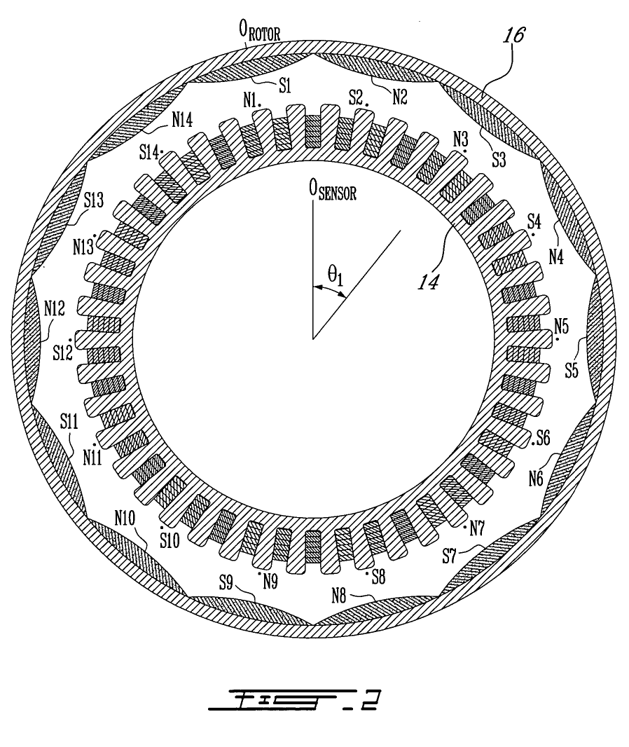

FIG. 1 schematically illustrates an electric motor 10 including a position sensor 12 and connected to a controller 18. The electric motor 10 further includes a stator 14 and a rotor 16 (see FIG. 2), the controller being electrically connected to the stator 14 (not shown) to supply current to windings. The position sensor 12 is so connected to the rotor 16 and to the stator 14 as to measure an angular position of the rotor 16 with respect to the stator 14. The absolute position sensor 12 is also connected to the controller 18 to supply angular data thereto.

As shown in FIG. 2, the electric motor 10 includes an external rotor 16 peripherally located with respect to the internal stator 14. However, it is also within the scope of the invention as defined in the appended claims to have an internal rotor located centrally with respect to a stator.

A specific example of an electric machine suitable for use with the claimed invention is a polyphasic synchronous electric motor provided with permanent magnets. More specifically, as shown in the drawings, the electric motor 10 is a tree-phase synchronous electric motor. However, any other suitable electric machine can be used without departing from the scope of the claimed invention.

Turning back to FIG. 1, in the schematic embodiment described herein, the controller 18 is also connected to a power supply in the form of a battery 20. The controller 18 controls the operation of the electric motor 10 and supplies electric power thereto. Of course, other power sources such as, for example flywheels, generators and/or fuel cells could be used.

Specifically, the controller 18, using power from the battery 20, injects electric signals into the stator 14 to control the angular position, the angular velocity and the angular acceleration of the electric motor 10 as a function of time. The controller 18 therefore controls the supply of power to the electric motor 10. In addition, the controller 18 performs a calibration of the position sensor 12, as described in further detail hereinbelow.

The position sensor 12 is an absolute position sensor. Therefore, the actual angle position of the rotor 16 with respect to the stator 14 cannot be directly read from the position sensor 12. Instead, the position sensor 12 returns an absolute angular position without any respect to the electric machine 10. To obtain the actual angular position of the rotor with respect to the stator, the angular relationship between the electric machine and the position sensor must be known. A method according to the present invention aims at determining this angular relationship between the electric machine and the position sensor.

The stator 14 shown in the drawings includes 14 poles created by three windings, and the rotor 16 includes seven pairs of poles. However, the reader skilled in the art will readily appreciate that the electric machine is any suitable electric machine including any number of poles in a stator and a rotor.

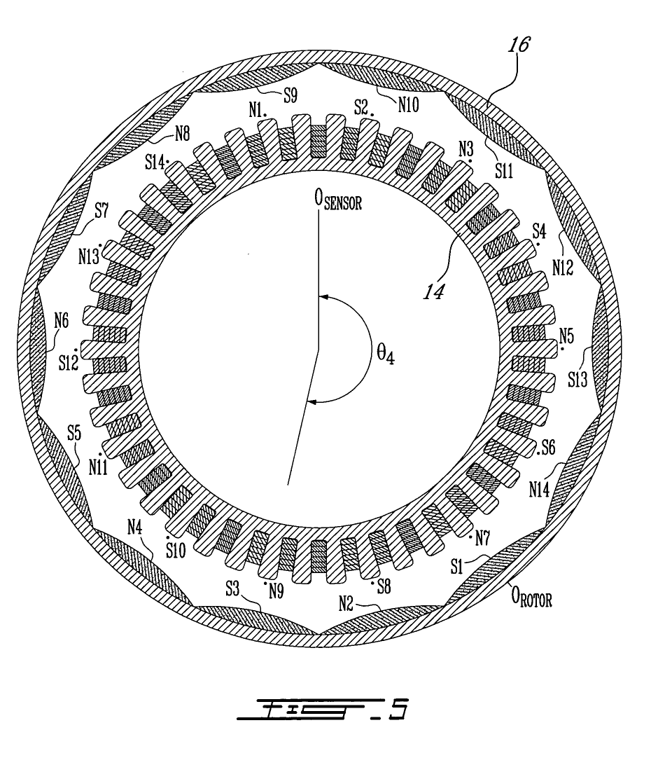

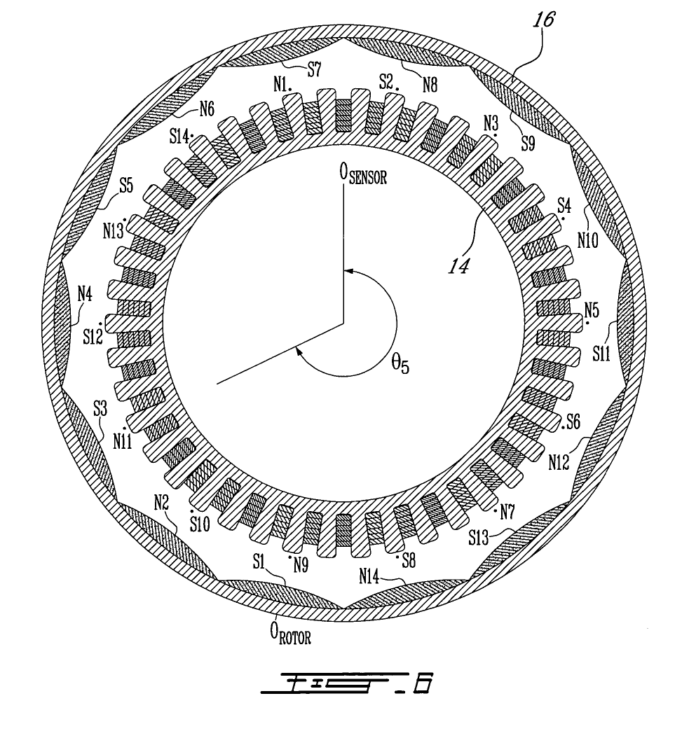

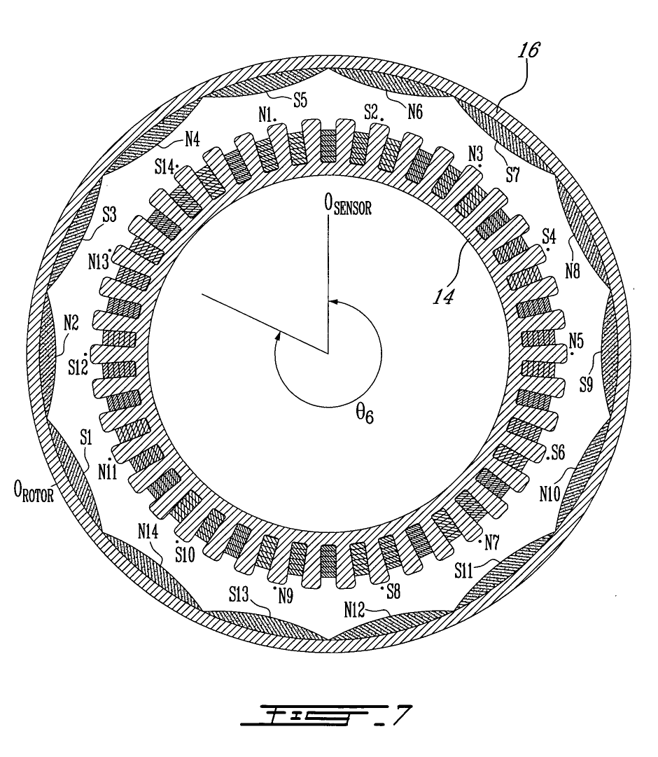

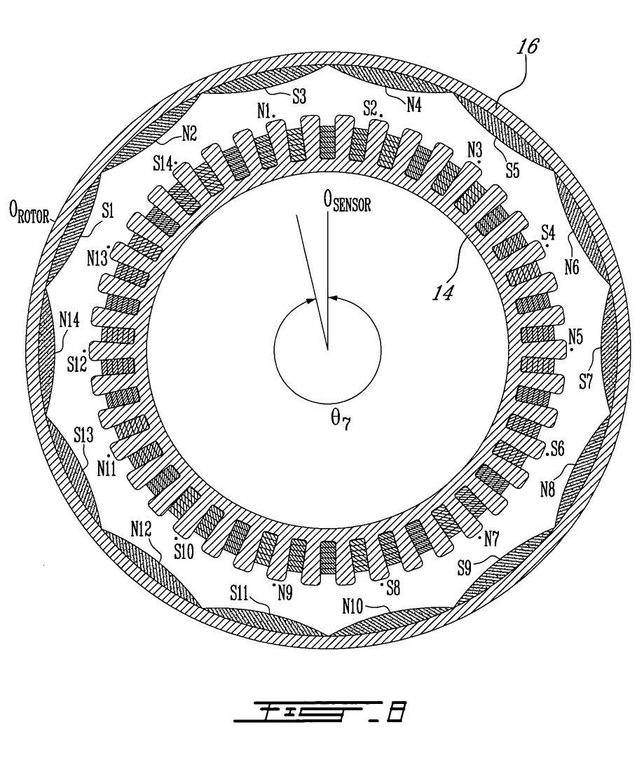

As shown in FIGS. 2 to 8, the poles of the rotor 16 are labeled as S1, N2, S3, N4, . . . S13, and N14. Similarly, the poles of the stator 14 are labeled as N1, S2, N3, S4, . . . N13, and S14. In this notation, poles having a label including the letter N are of opposite magnetic polarity to poles having a label including the letter S. Also, the number included in each label identifies sequentially the poles around the stator 16 or rotor 14, the number increasing in a clockwise direction.

In a specific example of implementation, the electric motor 10 is a motor of an electric vehicle, not shown in the drawings. For the purpose of this document, an electric vehicle is any vehicle including an electric motor used in the power train thereof. Therefore, electric vehicles include vehicles solely powered by electricity and hybrid vehicles, wherein an electric motor and a combustion engine are present, among others. Since the operation of such an electric vehicle is believed well-known in the art, it will not be further described herein.

For the purpose of this document, the position of the rotor 16 shown on FIG. 2 wherein the pole S1 of the rotor is aligned with the pole N1 of the stator will be referred to as zero degrees. It should be noted that in this position the position sensor 12 does not necessarily measure a position of zero. Indeed, an objective of the present invention is to map this zero position to the position as returned by the position sensor 12.

Briefly, referring to FIG. 2, the angle θ₁ is the offset between the 0 of the sensor and the 0 of the rotor. Indeed, the zero of the rotor (0ᵣₒₜₒᵣ) is aligned with the pole S₁ of the rotor. When this pole S₁ is aligned with the pole N₁ of the stator, the rotor is said to be at an angle of zero degrees. To get the reading zero degrees from the sensor, one must deduct θ₁ from t he returned angular position of the sensor.

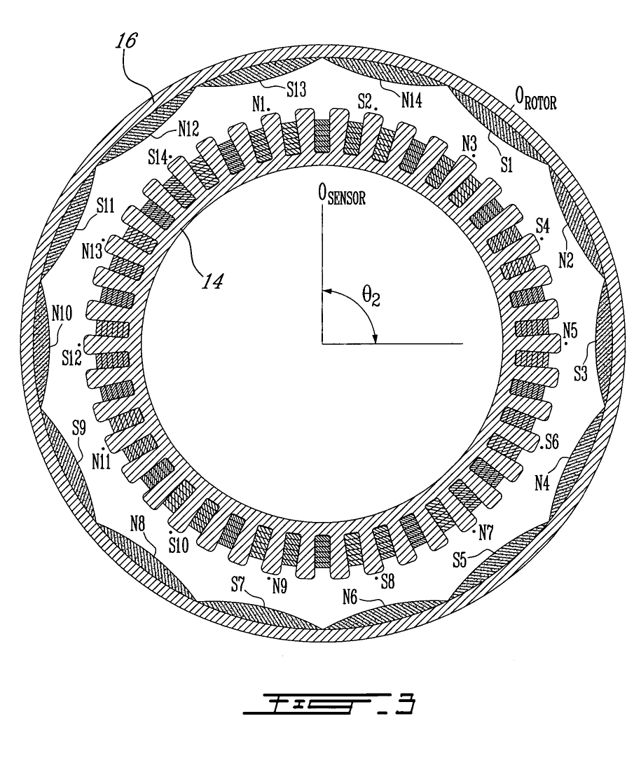

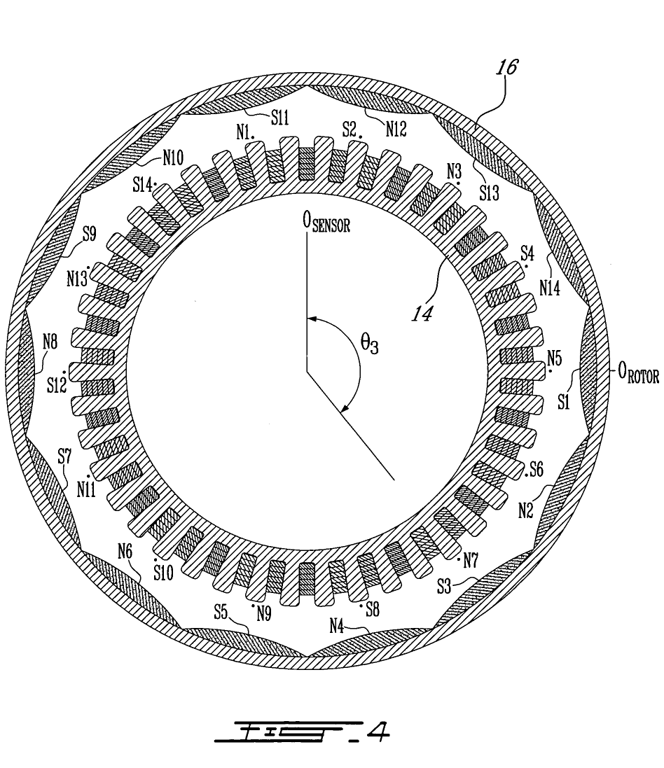

Similarly, an offset value is obtained from FIG. 3 by applying the formula:
Offset=θ₂−(360/7)
since we know that the rotor has theoretically moved 360/7 mechanical degrees between FIG. 2 and FIG. 3 since the electric machine has zeven pair of poles. The other offset values θ₃, θ₄, θ₅, θ₆, θ₇ respectively from FIGS. 4, 5, 6, 7 and 8 are calculated similarly.

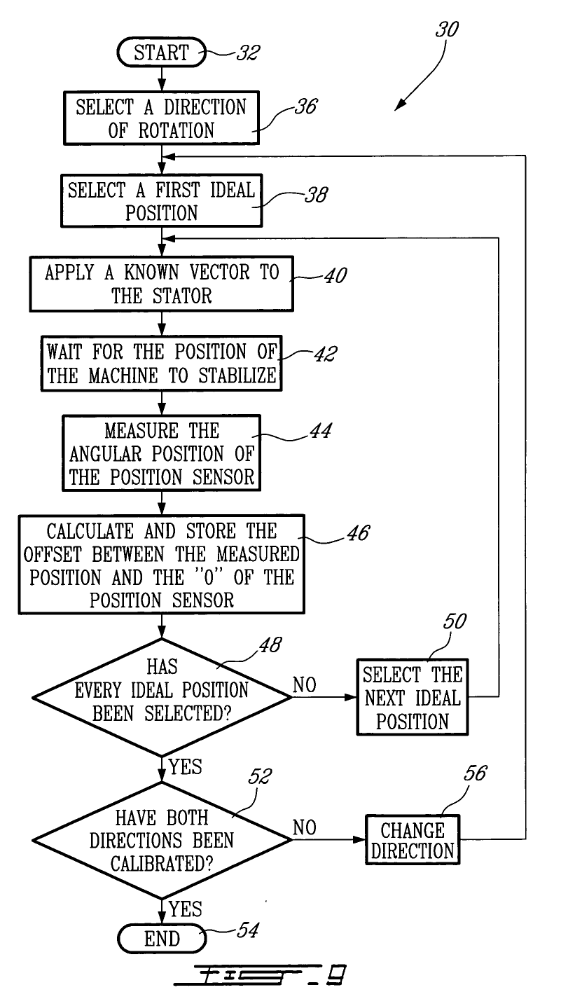

FIG. 9 illustrates a method 30 for calibrating the position sensor 12. The method 30 calibrates the position sensor by positioning the rotor 16 in proximity to a plurality of ideal positions. Then, for each ideal position, the position as returned by the position sensor 12 is read by the controller 18. This allows to know the actual angular position of the rotor 16 with respect to the stator 14 as a function of the returned angular position by the position sensor 12.

The method 30 starts at step 32.

Subsequently, for each predetermined ideal position from a plurality of predetermined ideal positions, an electric signal is injected by the controller 18 into the stator 14 to position the rotor 16 in proximity to the predetermined ideal position.

To that effect, the following steps are performed. At step 36, a direction of rotation is selected. Then, at step 38, a first ideal position of the rotor 16 is selected.

Subsequently, at step 40, a known vector of electric signals is applied to the windings of the stator 14 by the controller 18. The known vector is such that the rotor is positioned in the proximity of the selected predetermined ideal position.

Methods for controlling the rotor of an electric machine so as to achieve a known ideal position of the rotor 16 with respect to the stator 14 are believed well-known to those skilled in the art and therefore will not be described in further detail herein.

The controller 18 then waits for the position of the rotor 16 to stabilize, at step 42. For example, the controller 18 may wait for the position value returned from the position sensor to remain the same for a predetermined duration.

Next, an angular position is returned to the controller 18 from the position sensor 12. The returned position being associated with the selected predetermined ideal position. This is performed at step 44 of method 30.

At step 46, the controller 18 computes and stores an offset associated with the predetermined ideal position from the measured position. This maps the measured position to the predetermined ideal position.

Subsequently, at step 48, the controller 18 determines if every predetermined ideal position has been selected. If not, method 30 branches to step 50 wherein another predetermined ideal position is selected, and subsequently loops back to step 40.

If at step 48 every predetermined ideal position has been selected, the controller 18 then determines, at step 52, if the above-described steps have been performed with the rotor 16 rotating in both directions. If yes, the method ends at step 54. Otherwise, step 56 is performed to change the direction of rotation of the rotor 16 and subsequently the method loops back to step 38 to calibrate every predetermined ideal position while rotating in the other direction.

As will be discussed hereinbelow, the controller 18 uses the measured offset values to determine a relationship between the read value from the sensor and an actual angular position of the rotor.

The various ideal positions taken by the rotor 16 with respect to the stator 14 during the above-described method are illustrated in FIGS. 2 to 8 of the drawings.

FIG. 2 of the appended drawings illustrates the state of the electric motor 10 after the first execution of step 42 of method 30. In this state, the rotor 16 has been positioned in the above-mentioned zero degree position, i.e. the position where the pole S1 of the rotor 16 is aligned with the pole N1 of the stator. The angular position read by the position sensor 12 is θ₁. It is to be noted that since the position of the sensor 12 with respect to the rotor 16 and the stator 14 is arbitrary and depends on the particular assembly of the sensor 12 with respect to the rotor 16 and the stator 14. The angle θ₁ therefore varies from one electric machine to another.

At step 46, computing the offset associated with the predetermined ideal position includes deducting the predetermined ideal position from the measured position. From FIG. 2, the measured position is θ₁ and the predetermined ideal position is zero. Therefore, in this case, the offset is θ₁-0° and the value of θ₁ is mapped to a state of the electric motor 10 wherein the poles S1 and N2 are substantially aligned with the poles N1 and S2 of the stator 14.

FIG. 3 illustrates the state of the motor 10 after steps 44, 46, 48 and 50 have been executed further to the steps executed to arrive to the state shown in FIG. 2. In addition, to arrive at FIG. 3, steps 40 and 42 have been executed twice in method 30. In the state of the electric motor 10 shown in FIG. 3, the sensor 12 reads an angle θ₂.

In FIG. 3, the ideal position of the rotor 16 is equal to the position of the rotor in FIG. 2 to which an angle of a complete rotation divided by seven has been added. The number seven is selected because both the rotor 16 and the stator 14 each have seven pairs of poles. Accordingly, 360 electrical degrees separate the positions of the rotors illustrated i n FIGS. 2 and 3.

Therefore, this position provides a logical next step in the rotation of the stator 16. However, in alternative embodiments of the invention, predetermined ideal positions may correspond to any other suitable ideal position of the rotor 16. In the state of the electric motor shown in FIG. 3, the poles S1 and N2 of the rotor 16 are aligned with the poles N3 and S4 of the stator 14.

In other words, when the measured position is θ₂, the predetermined ideal position is 360/7 mechanical degrees. Therefore, in this case, the offset is θ₂-360/7° and the value of θ₂ is mapped to a state of the electric motor 10 wherein the poles S1 and N2 are aligned with the poles N3 and S4 of the stator 14, which corresponds to an ideal position of 360/7 mechanical degrees.

Similarly to FIGS. 2 and 3, FIGS. 4 to 8 show the state of the electric motor 1 0 wherein the position sensor reads θ₃, θ₄, θ₅, θ₆ and θ₇. Accordingly, FIGS. 4 to 8 respectively show the state of the motor 10 further to the third, fourth, fifth, sixth and seventh executions of step 42 in method 30. All the ideal positions differ by a factor of a complete rotation divided by seven. Accordingly, if angles are measured in mechanical degrees, the ideal positions shown in FIGS. 2 to 8 differ from each other by an angle of 360° divided by seven. In other words, the predetermined ideal positions are multiples of a full rotation of the rotor with respect to the stator divided by the number of dipoles of the rotor.

Therefore, in method 30, the plurality of predetermined ideal positions defines a sequence of positions. The vectors of electric signals are provided to the electric motor 10 so as to sequentially position the rotor 16 in the proximity of the predetermined ideal positions as ordered in the sequence of positions. The sequence of positions is such that the angular position of the rotor 16 first increases with each predetermined ideal position in the sequence of positions.

Also, although not shown in the drawings, the sequence of positions is also such that the angular position of the rotor 16, in addition to first increasing with each predetermined ideal position in the sequence of positions, subsequently decreases with each predetermined ideal position in the sequence of positions.

As will easily be understood by one skilled in the art, at step 42, the position is continuously read from the position sensor until the output of the position sensor does not vary anymore, for a predetermined duration, or only varies around an average value within a predetermined interval. Methods for determining the stability of a position read for position sensors are believed well known in the art and therefore will not be described in further detail herein.

The offsets determined by executing the method 30 are used to calibrate the position sensor 12. In a first example of calibration, the stored offsets associated with the predetermined ideal positions are used for computing a calibration parameter. An example of such a calibration parameter is an average calculated offset. Averaging allows for the reduction of errors on the position that could be introduced because of physical defects in the motor.

In another example of implementation, the calibration parameter is a vector parameter represented by a plurality of values. An example of a vector parameter is a vector parameter indicative of offsets interpolated at positions intermediate to the plurality of predetermined ideal positions.

In such a case, the vector parameter can be indicative of a plurality of straight-line segments interpolating the stored offsets between all possible pairs of contiguous predetermined ideal positions from the plurality of predetermined ideal positions. Then, the vector parameter includes a plurality of values representing slopes and offsets of a plurality of straight lines interpolating the offsets.

Alternatively, the vector parameters are indicative of any suitable interpolation parameters including, but not limited to, a spline-based interpolation of the offsets between the predetermined ideal positions from the plurality of predetermined ideal positions.

With a vector parameter, a map of the electric machine is provided. Such a map is useful in a case wherein the precision required for controlling the electric machine is greater than errors introduced in the structure of the electric motor 10 during fabrication. For example, the poles of the stator are typically not separated by exactly 360÷7° in the electric motor shown in the drawings. Such errors are introduced during manufacturing and are typically unavoidable.

Since the rotor 16 is positioned with respect to the stator 14 using electromagnetic fields induced by injecting electric signals into the windings of the stator 14, the position of the stator 14 for all the electromagnetic fields that are possibly induced inside the motor are known, which allows for the precise control of the injection of the signals into the electric motor as a function of the read position because the read positions then represent exactly the state of the electric motor 10.

It is to be noted that while the above description is concerned with an electric motor embodying the electric machine, the present invention could be advantageous when used in an electric generator.

Although the present invention has been described hereinabove by way of preferred embodiments thereof, it can be modified, without departing from the spirit and nature of the subject invention as defined in the appended claims.

What is claimed is:

1. A method for calibrating a position sensor in an electric machine including a stator and a rotor, the position sensor providing an angular position of the rotor with respect to the stator; for each of a plurality of predetermined ideal positions, said method comprising the steps of:
injecting an electric signal into the stator such as to position the rotor in proximity to the predetermined ideal position;
reading a measured position from the position sensor, the measured position being associated to the predetermined ideal position;
computing an offset associated with the predetermined ideal position from the measured position and the initial position; and
storing the offset, thereby mapping the measured position to the predetermined ideal position.

2. A method as recited in claim 1, wherein said position sensor is a relative position sensor.

3. A method as recited in claim 1, wherein:
the plurality of predetermined ideal positions defines a sequence of positions; and
said electric signal injecting step is so performed as to sequentially position the rotor in the proximity of the predetermined ideal positions as ordered in the sequence of positions.

4. A method as recited in claim 3, wherein the sequence of positions is such that the angular position of the rotor increases with each predetermined ideal position in the sequence of positions.

5. A method as recited in claim 3, wherein the sequence of positions is such that the angular position of the rotor first increases with each predetermined ideal position in the sequence of positions and then decreases with each predetermined ideal position in the sequence of positions.

6. A method as recited in claim 1, further comprising the step of computing a calibration parameter from the stored offsets associated with the predetermined ideal positions.

7. A method as recited in claim 6, wherein the calibration parameter includes an average calculated offset.

8. A method as recited in claim 6, wherein the calibration parameter includes a vector parameter.

9. A method as recited in claim 8, wherein the vector parameter is indicative of offsets interpolated at positions intermediate the plurality of predetermined ideal positions.

10. A method as recited in claim 1, wherein:
the rotor includes an integer number of dipoles N; and
the predetermined ideal positions are multiples of a full rotation of the rotor with respect to the stator divided by N.

11. A method as recited in claim 1, wherein said step of computing an offset associated with the predetermined ideal position from the measured position and the initial position includes deducting the predetermined ideal position from the measured position.

12. A method as recited in claim 1, wherein for each predetermined ideal position from the plurality of predetermined ideal positions, a step of waiting for a position of the rotor to stabilize is performed prior to said step of reading a measured position from the position sensor.

13. An electric machine comprising:
a stator;
a rotor;
a position sensor so connected to said rotor and to said stator as to measure an angular position of said rotor with respect to said stator;
a controller for controlling an operation of said electric machine, said controller using positions read from said position sensor to control the operation of said electric machine, said controller being operative to perform a calibration of said position sensor by:
for each predetermined ideal position from a plurality of predetermined ideal positions:
injecting an electric signal into the stator such as to position the rotor in proximity to the predetermined ideal position;
reading a measured position from the position sensor, the measured position being associated to the predetermined ideal position;
computing an offset associated with the predetermined ideal position from the measured position and the initial position; and
storing the offset, thereby mapping the measured position to the predetermined ideal position.

14. An electric machine as recited in claim 13, wherein said position sensor is a relative position sensor.

15. An electric machine as recited in claim 13, wherein:
the plurality of predetermined ideal positions defines a sequence of positions; and
the electric signal injection is so performed as to sequentially position said rotor in the proximity of the predetermined ideal positions as ordered in the sequence of positions.

16. An electric machine as recited in claim 15, wherein the sequence of positions is such that the angular position of said rotor with respect to the initial position increases with each predetermined ideal position in the sequence of positions.

17. An electric machine as recited in claim 13, wherein said controller is operative to compute a calibration parameter from the stored offsets associated with the predetermined ideal positions.

18. An electric machine as recited in claim 13, wherein:
said rotor includes an integer number of dipoles N; and
the predetermined ideal positions are multiples of a full rotation of the rotor with respect to the stator divided by N.

19. An electric machine as recited in claim 13, wherein the computing of an offset associated with the predetermined ideal position from the measured position and the initial position includes deducting the predetermined ideal position from the measured position.

20. An electric machine as recited in claim 13, wherein said electric machine is a polyphasic electric machine.

21. An electric machine as recited in claim 13, wherein for each predetermined ideal position from a plurality of predetermined ideal positions, said controller is operative to wait for a position of said stator to stabilize prior to reading a measured position from said position sensor, the measured position being associated to the predetermined ideal position.
